(19) United States
(12) Patent Application Publication
(10) Pub. No.: US 2020/0319597 A1
(43) Pub. Date: Oct. 8, 2020

(54) ANTISHOCK DEVICE AND TIMEPIECE MECHANICAL OSCILLATOR WITH FLEXIBLE GUIDANCE HAVING SUCH AN ANTISHOCK DEVICE

(71) Applicant: CSEM Centre Suisse d'Electronique et de Microtechnique SA - Recherche et Developpement, Neuchatel (CH)

(72) Inventors: Gregory Musy, Le-Mont-sur-Lausanne (CH); Francois Barrot, Erlach (CH)

(21) Appl. No.: 16/839,137

(22) Filed: Apr. 3, 2020

(30) Foreign Application Priority Data
Apr. 4, 2019 (CH) 00461/19

(51) Int. Cl. G04B 31/02; G04B 43/00; G04B 17/04

(52) U.S. Cl. CPC G04B 31/02; G04B 17/04; G04B 43/002

(57) ABSTRACT

An antishock device intended to protect from shocks a timepiece mechanical oscillator with flexure guiding, the antishock device including a visco-elastic element and a rigid stop, each being configured in such a manner as to cooperate with a portion of the oscillator. The visco-elastic element is configured to be deformed elastically if the oscillator is subjected, in the event of a shock, to an acceleration between 20 G and 1000 G NIHS, preferably between 50 G and 500 G NIHS. The portion cooperating with the rigid stop if the portion is subjected to an acceleration beyond at least 1000 G NIHS, preferably at least 500 G. A timepiece mechanical oscillator includes a balance, a suspension with flexure guiding and elastically restoring the balance into a plane of oscillation and provided with shock protection, the oscillator including at least one antishock device according to the invention.

### TECHNICAL FIELD

The present invention concerns an antishock device with rigid stop and a timepiece mechanical oscillator with flexure guiding having such an antishock device. The present invention also concerns a timepiece mechanical oscillator comprising said antishock device.

### PRIOR ART

In the field of high-precision micromechanics and that of horology in particular, the use of so-called antishock devices to protect components, for example those of a watch, is well known.

The document EP3076245 describes a shock and/or vibration damping device comprising a flexible element adapted to be deformed by the effect of a stress and a so-called dissipative layer produced from a material having a shear modulus lower than the shear modulus of the flexible element at least partly secured to said flexible element.

The document EP3324246 describes rigid axial stop means suitable for the protection of the blade resonator mechanism against axial shocks in the direction of the shaft.

In the case of the antishock devices described in EP3076245 and EP3324246, the antishock device cooperates with a pivot shaft related to the centre of the oscillator. The part of the shaft that comes into contact with the antishock device is always the same whatever the intensity of the shock, namely the end of the shaft for axial shocks and the bearing surface at the end of the shaft for radial shocks. The diameter of the bearing surface at the end of the shaft must therefore be sufficiently large for no shock, whatever its intensity, to be able to damage it. This implies a large shaft diameter or a long lever arm that generates a high friction torque on the balance in the event of a shock.

Wearing shocks (<500 G NIHS) can easily occur and repeat at a high frequency. Thus a high friction torque associates with wearing shocks (<500 G NIHS) repeated at a high frequency may lead to a severe loss of amplitude of the balance or even to stopping or jamming of the mechanism. This is all the more critical for oscillators with flexure guiding that generally operate with a low nominal amplitude.

### SUMMARY OF THE INVENTION

An object of the present invention is to minimize the friction between an oscillator with flexure guiding and its antishock device and therefore to reduce the loss of amplitude of the oscillator following wearing shocks, which is particularly critical for oscillators with flexure guiding that generally have on the one hand a low nominal amplitude and on the other hand an escapement that is not self-starting and may jam if the amplitude of the oscillator is too low

The present invention integrates a visco-elastic spring and associates it with a rigid stop so that the wearing shocks are absorbed by the visco-elastic antishock device and accidental shocks by the rigid stop.

Wearing shocks are defined by the standard NIHS 91-30, “Definition of linear accelerations encountered by a wristwatch on sudden gestures and wearing shocks”. Accidental shocks are defined by the standard NIHS 91-20, “Definition of linear shock types for wristwatch components”. The standard NIHS 91-10 specifies the minimum requirement applicable to shock-resistant watches and describes the corresponding test method.

According to the invention, these objects are achieved in particular by means of an antishock device comprising a visco-elastic element and a rigid stop, each being configured in such a manner as to cooperate with a portion of the oscillator; in which the visco-elastic element is configured in such a manner as to be deformed elastically if the oscillator is subjected, in the event of a shock, to an acceleration between 20 G and 1000 G NIHS, preferably between 50 G and 500 G NIHS; in which said portion cooperates with the rigid stop if the portion is subjected to an acceleration beyond at least 1000 G NIHS, preferably at least 500 G NIHS; and in which there is no contact between said portion of the oscillator and the antishock device for an acceleration less than 50 G NIHS.

The present invention also concerns a timepiece mechanical oscillator comprising a balance, a suspension with flexure guiding guiding and elastically restoring the balance into an oscillation plane and provided with shock protection, the oscillator comprising at least one antishock device according to the invention.

In this context and in contrast to the antishock devices described in EP3076245 and EP3324246, the antishock device of the present invention interacts with a shaft having two different bearing surfaces each characterized by a specific diameter. Accordingly, the shaft bearing surface characterized by the smaller diameter cooperates with the visco-elastic spring for wearing shocks whereas the shaft bearing surface characterized by the greater diameter cooperates with the rigid stop for accidental shocks. This enables minimization of friction and therefore of the loss of amplitude of the balance following wearing shocks by guaranteeing that the shaft is not damaged for accidental shocks of high intensity (>500 G NIHS).

The operation of the antishock device of the present invention is similar to that of the Incabloc® antishock device for wearing shocks in the range 20 G to 1000 G NIHS (or 50 G to 500 G NIHS) and for accidental shocks from 1000 G to 5000 G NIHS, except for the difference that the antishock device of the invention dissipates the energy of the wearing shocks from 20 G to 1000 G NIHS (or 50 G to 500 G NIHS) through the viscosity of the spring whatever the direction of the shock whereas the Incabloc® dissipates only the energy of radial shocks by dry friction and does not dissipate any of the energy of axial shocks. Dissipating the energy of the shock is important because the more rebounds there are following the shock between the oscillator and the antishock device the longer the oscillator will rub against the antishock device and the greater will be the resulting loss of amplitude of the oscillator. For wearing shocks in the range 0 G to 50 G NIHS the operation of the present invention is completely different from that of the Incabloc®. Indeed, the Incabloc® must simultaneously provide the function of guidance of the shaft of the balance and the antishock function. This implies that the spring of the Incabloc® is preloaded so that the bearing guiding the balance is not moved by very low wearing shocks (<50 G NIHS). This enables guidance of the balance except in the case of strong disturbance (>50 G NIHS).

For the oscillator of the present invention, guidance is provided by the flexible pivot. There is therefore no contact between the attached shaft and the antishock device for low wearing shocks (<50 G NIHS). Because of this, it is on the one hand not necessary to preload the visco-elastic spring and on the other hand the balance is less disturbed by this type of shock than in the case of the Incabloc®.

### BRIEF DESCRIPTION OF THE FIGURES

Embodiments of the invention are indicated in the description illustrated by the appended figures, in which:

FIG. 1 shows a view from above of a mechanical oscillator including an antishock device in accordance with one embodiment;

FIG. 2 shows a view from above of the mechanical oscillator from FIG. 1 without the antishock device;

FIG. 3 shows a view in section of the antishock device in accordance with one embodiment;

FIG. 4 shows a view in section of the timepiece mechanical oscillator according to one embodiment; and

FIG. 5 shows a view in section of the shaft of the balance according to one embodiment;

FIG. 6 shows the antishock device according to another embodiment; and

FIG. 7 shows the antishock device in accordance with a further embodiment.

### EMBODIMENT(S)

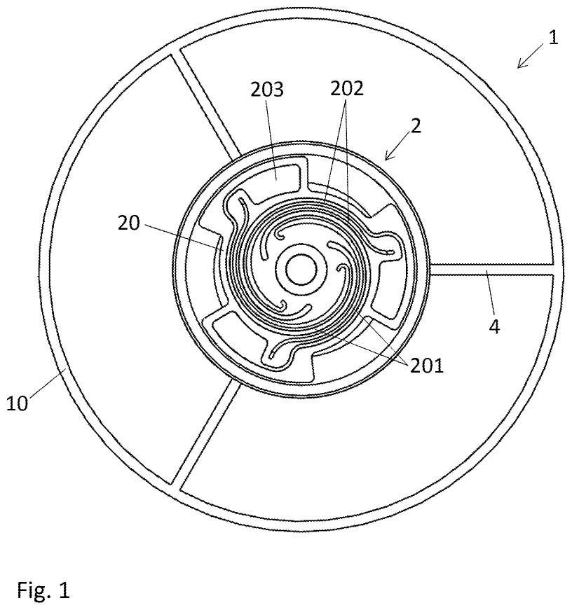

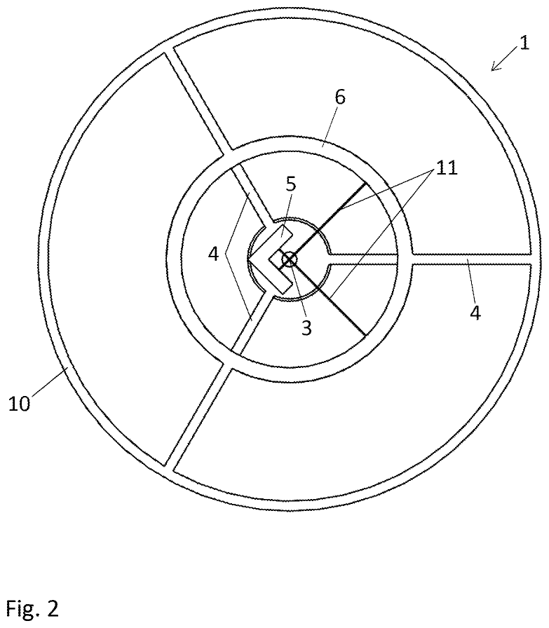

FIG. 1 shows a view from above of a mechanical oscillator 1 with flexure guiding for a timepiece movement in accordance with one embodiment. The mechanical oscillator 1 includes an antishock device 2 intended to protect from shocks the timepiece mechanical oscillator 1 with flexure guiding. FIG. 2 shows a view from above of the mechanical oscillator 1 without the antishock device in order to make visible some components of the oscillator 1.

The oscillator comprises a balance 10, a suspension 11 with flexure guiding guiding and elastically restoring the balance 10 into an oscillation plane. The suspension 11 with flexure guiding connects the balance 10 to a fixed base 5 of the oscillator 1. The base 5 is intended to be fixed to a fixed part of the timepiece movement. The oscillator 1 comprises a shaft 3 rigidly connected to the balance 10 by a rigid connection 4 that attaches this shaft 3 at the centre of rotation of the balance 10. In the example shown, the suspension with flexure guiding includes elastic blades 11 connecting the base 5 to the balance 10 via a rigid ring 6 secured to the rigid connection 4.

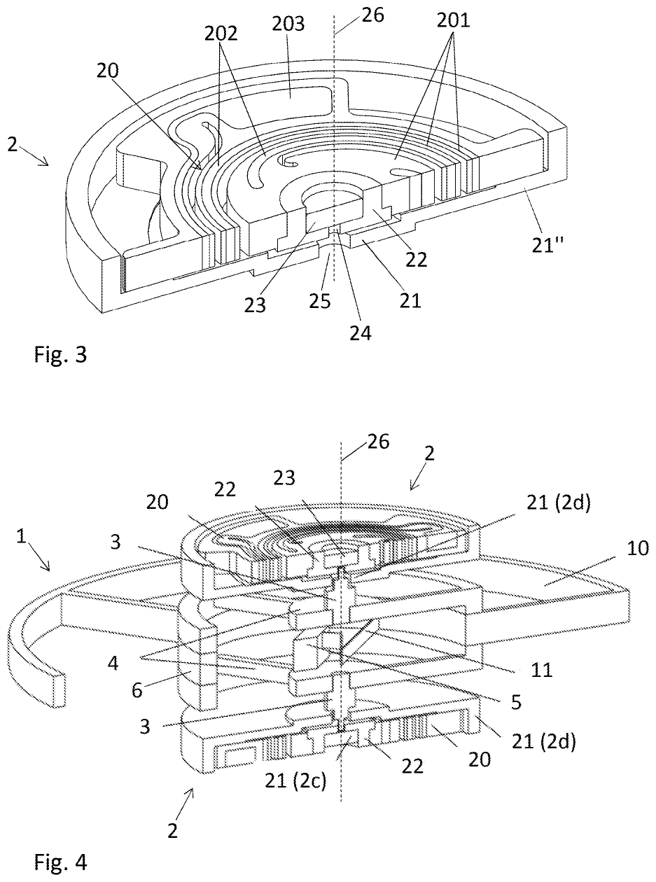

FIG. 3 shows a view in section of the antishock device 2 in accordance with one embodiment. The antishock device 2 comprises a visco-elastic element 20 and a rigid stop 21 each configured in such a manner as to cooperate with a portion of a timepiece oscillator (for example the shaft 3). The visco-elastic element 20 is configured in such a manner as to deform elastically if the oscillator is subjected, in the event of a shock, to an acceleration between 50 G and 500 G NIHS, so as to damp the shock. For an acceleration beyond at least 500 G NIHS, the oscillator comes to abut against the rigid stop 21.

The stiffness of the visco-elastic element 20 is more particularly adjusted in such a manner that said portion of the oscillator (for example the shaft 3) cooperates with the visco-elastic element 20 when the oscillator is subjected to an acceleration between 50 G and 500 G NIHS and cooperates with the rigid stop 21 if the oscillator is subjected to an acceleration beyond at least 500 G NIHS.

According to the embodiment shown in FIG. 3, the visco-elastic element 20 comprises a plurality of flexible blades 201 each comprising a visco-elastic material 202. One end of each of said flexible blades is secured to an intermediate part 22 intended to cooperate with the portion of the oscillator 1. This embodiment of the visco-elastic element 20 is similar to that described in the document EP3076245.

Still in accordance with the configuration shown in FIG. 3, the intermediate part 22 takes the form of a disc (or cylinder) from which extend the plurality of flexible blades 201 (three flexible blades 201 in FIG. 3). The flexible blades 201 may be curved in a spiral pattern, the centre of the spiral coinciding with a central shaft 26 of the intermediate part 22. The curved blades may comprise a recess forming a reservoir 203 opening between two flexible blades 201 enabling flow, for example by capillarity, of the visco-elastic material 202 between the flexible blades 201 during the manufacturing process.

In this configuration, if the oscillator is subjected to an acceleration between 50 G and 500 G NIHS, the visco-elastic element 20 damps the shock through the deformation of the visco-elastic material 202 of the flexible blades 201. If the oscillator is subjected to an acceleration beyond at least 500 g, the flexible blades 201 are sufficiently deflected for contact to occur between the portion (the shaft 3) of the oscillator at the rigid stop 21.

If the oscillator is subjected to an acceleration between 50 G and 500 G NIHS, the flexible blades 201 may more particularly be deflected radially and axially (for example relative to the central shaft 26). In this configuration the visco-elastic element 20 damps a shock suffered by the oscillator in the axial direction and in the radial direction, that is to say in the plane in which the flexible blades 201 extend, a plane perpendicular to the central shaft 26.

To this end, the flexible blades 201 may have an axial stiffness and a radial stiffness that are adjusted so that the portion of the oscillator (the shaft 3) cooperates with the visco-elastic element 20 if the oscillator is subjected to an acceleration, respectively axial and radially, between 50 G and 500 G NIHS, and cooperates with the rigid stop 21 if the oscillator is subjected to an acceleration, respectively axial and radial, beyond at least 500 G NIHS.

Still in accordance with the configuration shown in FIG. 3, the intermediate part 22 includes a first housing 24 configured to cooperate with the portion of the oscillator (the shaft 3). The rigid stop 21 takes the form of a disc disposed under the visco-elastic element 20. The rigid stop 21 includes a second housing 25 also configured to cooperate with the portion of the oscillator (the shaft 3).

In accordance with one embodiment the first housing 24 is blind. A stone 23 may be positioned in the bottom of the first housing 24.

The flexible blades 201 may be made of silicon. The visco-elastic material 202 may then be contained between the flexible blades 201 or in the flexible blades 201. For example, the visco-elastic material 202 may be deposited in a cavity formed in the flexible blade 201. Let us note that, as silicon withstands little local plastic deformation, the intermediate part 22 (and the stone 23) that is called upon to be in direct contact with the portion of the oscillator may be made from a material other than silicon, more resilient than silicon. The visco-elastic material 202 advantageously has a low shear modulus, i.e. a shear modulus preferably less than 10 GPa, a loss factor of at least 0.1. The visco-elastic material 202 preferably has a shear modulus at least ten times lower than the shear modulus of the flexible blade or blades 201. To this end, the visco-elastic material 202 may comprise a polymer, preferably an elastomer.

Alternatively, the flexible blades 201 may be made from a metal or metal alloy, for example with the aid of an LIGA (Lithography, Electroplating, and Moulding) type method or by laser cutting.

The role of the flexible blades 201 is to enable movement of the visco-elastic element 202 if the oscillator 1 is subjected, in the event of a shock, to an acceleration between 20 G and 1000 G (typically between 50 G and 500 G), which enables damping of the shock (dissipation of all or part of the energy of the shock) without jamming and/or braking the principal mode of oscillation of the oscillator 1. FIG. 4 shows a view in section of the timepiece mechanical oscillator 1 with flexure guiding in accordance with an embodiment in which the oscillator 1 comprises two shafts 3 each rigidly connected to the balance 10 by the rigid connection 4. The two shafts 3 and the two rigid connections 4 are arranged in a coaxial manner. Each of the two shafts 3 cooperates with an antishock device 2. In other words, the oscillator 1 comprises an upper shaft 3 cooperating with an upper antishock device 2 and a lower shaft 3 cooperating with a lower antishock device 2.

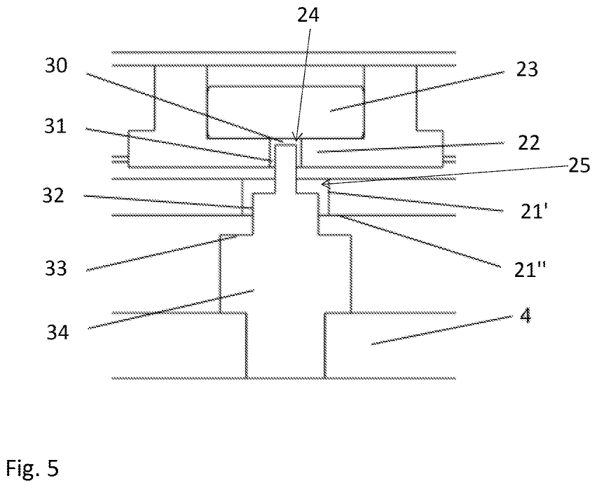

FIG. 5 shows a view in section of the upper shaft 3 and of the central part of the upper antishock device 2 in accordance with one embodiment.

In accordance with one embodiment each shaft 3 comprises at least a shaft end 30, a bearing surface 31 at the end having a small diameter and connected to the shaft end 30, a proximal bearing surface 32 of greater diameter than the bearing surface 31 at the end and a shoulder 33 connecting the proximal bearing surface 32 to the base 34 of the shaft 3.

If the oscillator 1 suffers a shock in the radial direction with a radial acceleration between 50 G and 500 G NIHS, the bearing surface 31 at the end cooperates with the visco-elastic element 20. The proximal bearing surface 32 cooperates with the rigid stop 21 if the radial acceleration is beyond at least 500 G NIHS. For example, the bearing surface 31 at the end cooperates with the lateral edges of the first housing 24 and the proximal bearing surface 32 cooperates with the lateral edges 21′ of the second housing 25.

If the oscillator 1 suffers a shock in the axial direction with an axial acceleration between 50 G and 500 G NIHS, the shaft end 30 cooperates with the visco-elastic element 20. The shoulder 33 cooperates with the rigid stop 21 if the radial acceleration is beyond at least 500 G NIHS. For example, the shaft end 30 cooperates with the bottom (the stone 23) of the first housing 24 and the shoulder 33 cooperates with a lower plane 21″ of the rigid stop 21.

Let us note that for shocks of very low intensity (<50 G NIHS), the shaft 3 does not come into contact with the antishock device 2. It is the mass and stiffness properties of the oscillator 1 and likewise the clearances between the shaft 3 and the intermediate part 22 (and the stone 23) that determines this level of shock for a first contact between the oscillator 1 and the antishock device 2.

It is the mass and stiffness properties of the oscillator 1, the clearances between the shaft 3 and the rigid stop 21 and finally the axial and radial stiffnesses of the visco-elastic element 20 that determine this level of shock for a first contact between the oscillator 1 and the rigid stop 21. Thus the visco-elastic element 20 serves above all to prevent the shaft 3 coming into contact with the rigid stop 21 for wearing shocks at least less than 500 G NIHS.

The antishock device 2 can deform and damp post-shock vibrations radially and axially; it also enables dissipation of the tip/tilt rotation movements that may occur (and even be superimposed on the radial and axial movements) following shocks of the oscillator on the stop. The behaviour of the anti-shock device 2 may be similar for axial and radial shocks.

Compared to the known antishock devices, the oscillator 1 of the invention comprising two antishock devices 2 enables reduction of the diameter of the bearing surface 31 at the end collaborating with the antishock device in order to minimize friction for shocks at least less than 500 G NIHS. There is also better dissipation of the energy of tip/tilt axial, radial shocks at least less than 500 G NIHS compared to known antishock devices.

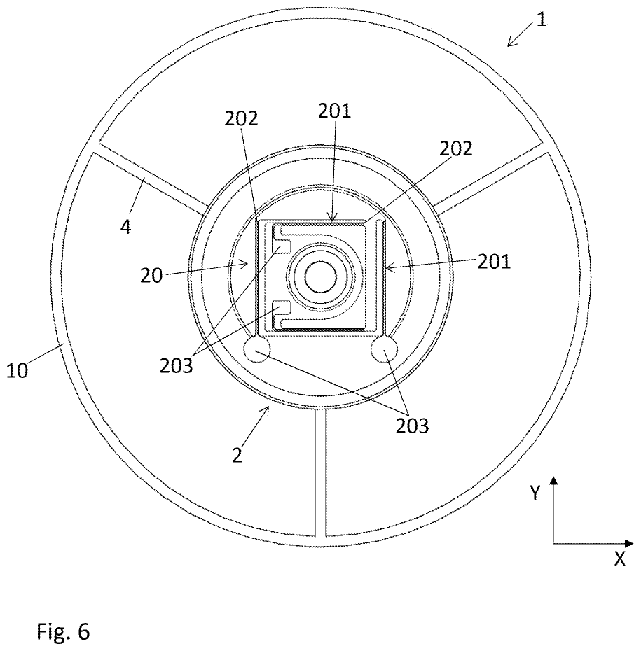

Other possible configurations of the visco-elastic element 20 enabling the function of flexure guiding of the flexible blades 201 to be achieved can also be envisaged. For example, FIG. 6 shows a view from above of the oscillator 1 comprising the antishock device 2 in which the flexible blades 201 curved in a spiral pattern are replaced by an XY table structure. In the example from FIG. 6 the visco-elastic element 20 includes a pair of essentially parallel flexible blades 201 oriented along an axis X and a pair of essentially parallel flexible blades 201 oriented along an axis Y. Reservoirs 203 enable flow of the visco-elastic material 202 between each of the pairs of flexible blades 201.

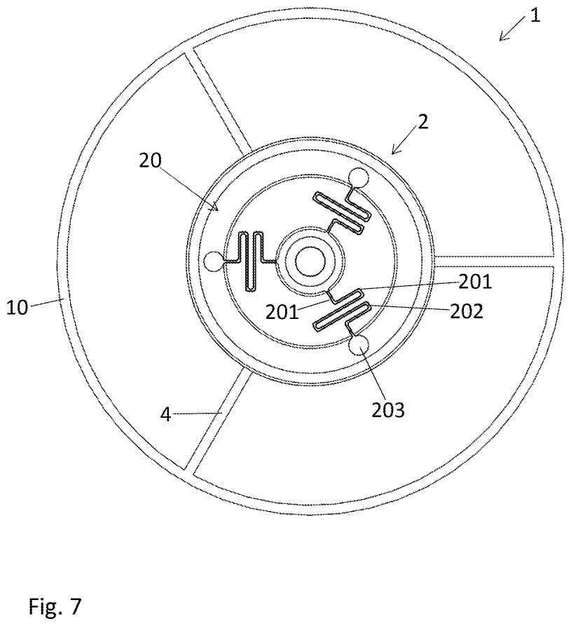

In a further embodiment shown in FIG. 7 the flexible blades 201 curved in a spiral pattern are replaced by a star structure. The antishock device 2 may particularly includes accordion type flexible blades 201. Reservoirs 203 enable flow of the visco-elastic material 202 between two parallel flexible blades 201.

In the variants of the antishock device 2 shown in FIGS. 6 and 7, the visco-elastic element 20 may have dimensions such as to have a flexibility equivalent to that of the visco-elastic element 20 in which the flexible blades 201 have a spiral configuration. Just like the implementation of the antishock device shown in FIGS. 1 to 5, the variants of the antishock device 2 represented in FIGS. 6 and 7 therefore enable “tip-tilt-pistons” and radial movements of the balance 10 following a shock to be absorbed, whilst dissipating (by visco-elastic effect) the energy of the shock. For example, the dimensions of the visco-elastic element 20 may be based on a judicious choice of the following parameters: the number of flexible blades 201, the type of visco-elastic material, the material constituting the blades, the geometry of those blades, such as their thickness, their width, their height, their length and the ratio between these dimensions.

The reservoirs 203 may have dimensions such as, as in the spiral configuration of the visco-elastic element 20, to enable the deposition of a visco-elastic polymer, for example by capillarity, between the two facing faces of the elastic blades 201, thus producing a sandwich structure of which the visco-elastic material 202 constitutes the core.

### REFERENCE NUMBERS EMPLOYED IN THE FIGURES

1 oscillator
10 balance
11 suspension with flexure guiding
2 antishock device
20 visco-elastic element, visco-elastic spring
201 flexible blade
202 visco-elastic material
203 reservoir
21 rigid stop
21′ lateral edges of second housing
21″ lower plane of rigid stop
22 intermediate part
23 stone
24 first housing
25 second housing
26 central shaft
3 shaft
30 shaft end
31 bearing surface at end
32 proximal bearing surface
33 shoulder
34 base of shaft
4 rigid connection
5 base
6 rigid ring

1. Antishock device intended to protect from shocks a timepiece mechanical oscillator with flexure guiding, the antishock device comprising:
a visco-elastic element and a rigid stop, each being configured in such a manner as to cooperate with a portion of the oscillator;
the visco-elastic element being configured in such a manner as to be deformed if the oscillator is subjected, in the event of a shock, to an acceleration between 20 G and 1000 G NIHS, preferably between 50 G and 500 G NIHS;
said portion cooperating with the rigid stop if the portion is subjected to an acceleration beyond at least 1000 G NIHS, preferably at least 500 G NIHS;
and in which there is no contact between said portion of the oscillator and the antishock device for an acceleration less than 50 G NIHS.

2. Antishock device according to claim 1,
in which the stiffness of the visco-elastic element is adjusted in such a manner that the portion of the oscillator cooperates with the visco-elastic element if the oscillator is subjected to an acceleration between 20 G and 1000 G NIHS, preferably between 50 G and 500 G NIHS, and cooperates with the rigid stop if the oscillator is subjected to an acceleration beyond at least 1000 G NIHS, preferably at least 500 G NIHS.

3. Antishock device according to claim 1,
in which the visco-elastic element comprises a plurality of flexible blades each comprising a visco-elastic material.

4. Antishock device according to claim 3,
in which an end of each said flexible blades is secured to an intermediate part intended to cooperate with the portion of the oscillator.

5. Antishock device according to claim 4,
in which the intermediate part takes the form of a circular cylinder from which extends a plurality of flexible blades, the intermediate part including a first housing configured to cooperate with said portion.

6. Antishock device according to claim 4,
in which the flexible blades are curved in a spiral pattern, the centre of the spiral coinciding with a central axis of the intermediate part and the housing.

7. Antishock device according to claim 5,
in which the rigid stop takes the form of a circular cylinder and includes a second housing configured to cooperate with said portion.

8. Timepiece mechanical oscillator comprising a balance, a suspension with flexure guiding guiding and elastically restoring the balance into a plane of oscillation and provided with protection against shocks, in which the oscillator comprises at least one antishock device comprising a visco-elastic element and a rigid stop, each being configured in such a manner as to cooperate with a portion of the oscillator; the visco-elastic element being configured in such a manner as to deform if the oscillator is subjected, in the event of a shock, to an acceleration between 20 G and 1000 G NIHS, preferably between 50 G and 500 G NIHS; said portion cooperating with rigid stop if the portion suffers an acceleration beyond at least 1000 G NIHS, preferably at least 500 G NIHS; and in which there is no contact between said portion of the oscillator and the antishock device for an acceleration less than 50 G NIHS.

9. Oscillator according to claim 8,
comprising a shaft rigidly connected to the balance, the shaft cooperating with the visco-elastic element and the rigid stop.

10. Oscillator according to claim 9,
in which the shaft comprises a bearing surface at the end cooperating with the visco-elastic element if the shaft suffers a radial acceleration between 20 G and 1000 G NIHS, preferably between 50 G and 500 G NIHS, and a proximal bearing surface cooperating with the rigid stop if the shaft suffers a radial acceleration beyond at least 1000 G NIHS, preferably at least 500 G NIHS.

11. Oscillator according to claim 10,
in which the shaft comprises a shaft end cooperating with the visco-elastic element if the shaft suffers an axial acceleration between 20 G and 1000 G NIHS, preferably between 50 G and 500 G NIHS; and
in which the proximal bearing surface is of greater diameter than the bearing surface at the end in such a manner as to form a shoulder, the shoulder cooperating with the rigid stop if the shaft suffers an axial acceleration beyond at least 1000 G NIHS, preferably at least 500 G NIHS.

12. Oscillator according to claim 10,
in which the intermediate part takes the form of a circular cylinder including a first housing, the bearing surface at the end cooperating with the first housing.

13. Oscillator according to claim 10,
in which the rigid stop takes the form of a circular cylinder and includes a second housing concentric with the first housing and of greater diameter than the latter, the proximal bearing surface cooperating with the second housing.

14. Oscillator according to claim 11,
in which the intermediate part takes the form of a circular cylinder including a first housing, the bearing surface at the end cooperating with the first housing,
in which the first housing is blind, and
in which the shaft end cooperates with the first housing bottom.

15. Oscillator according to claim 14,
in which the first housing bottom includes a stone.

16. Oscillator according to claim 11,
in which the rigid stop takes the form of a circular cylinder and includes a second housing concentric with the first housing and of greater diameter than the latter, the proximal bearing surface cooperating with the second housing, and
in which the shoulder cooperates with a lower plane of the rigid stop.

17. Oscillator according to claim 8, including two antishock devices disposed on each side of the balance.
